(19) United States
(12) Patent Application Publication
(10) Pub. No.: US 2003/0220889 A1
(43) Pub. Date: Nov. 27, 2003

(54) Analog accumulator for neural networks

(76) Inventors: Bingxue Shi, Beijing (CN); Chun Lu, Beijing (CN); Lu Chen, Beijing (CN)

Correspondence Address: Finnegan, Henderson, Farabow,, Garrett & Dunner, L.L.P., 1300 I Street, N.W., Washington, DC, 20005-3315, US

(21) Appl. No.: 10/150,941

(22) Filed: May 21, 2002

(51) Int. Cl. G06N 3/067; G06N 3/063; G06F 15/18; G06G 7/00; G06E 3/00; G06E 1/00; G06N 3/06

(52) U.S. Cl. 706/26; 706/38

(57) ABSTRACT

A neural network includes a neuron, an error determination unit, and a weight update unit. The weight update unit includes an analog accumulator. The analog accumulator requires a minimal number of multipliers.

### DESCRIPTION OF THE INVENTION

1. Field of the Invention

The present invention relates to an analog neural network.

2. Background of the Invention

A neural network is an interconnected assembly of simple processing elements, called neurons, whose functionality is loosely based on the human brain, in particular, the neuron. The processing ability of the network is stored in inter-neuron connection strengths, called weights, obtained by learning from a set of training patterns. The learning in the network is achieved by adjusting the weights based on a learning rule and training patterns to cause the overall network to output desired results.

The basic unit of a neural network is a neuron. FIG. 1 is an example of a neural network neuron 100. Neural network neuron 100 functions by receiving an input vector X composed of elements x₁, x₂, . . . . xₙ. Input vector X is multiplied by a weight vector W composed of elements w₁, w₂, . . . wₙ. The resultant product is inputted into a linear threshold gate (LTG) 110. LTG 110 sums the product of X and W. The sum is then compared with a threshold value T. An output value y is output from LTG 110 after the sum is compared to threshold value T. If the sum is greater than threshold value T, a binary 1 is output as y. If the sum is less than the threshold value T, a binary 0 is output as y.

A conventional neural network is composed of multiple neurons arranged in layers. FIG. 2 is a diagram of a conventional neural network 200. Conventional neural network 200 is composed of two layers, a first layer 210 and a second layer 220. First layer 210 comprises a k number of neurons. Second layer 220 comprises a single neuron. The neurons in first layer 210 and second layer 220 may be, for example, an LTG such as LTG 110 illustrated in FIG. 1. Conventional neural network 200 functions by receiving an input vector X composed of elements x₁, x₂, and xₙ at first layer 210. First layer 210 processes input vector X and outputs the results to second layer 220. The neurons of first layer 210 may process input vector X by the method described for the neuron shown in FIG. 1. The results outputted from first layer 210 are inputted into second layer 220. Second layer 220 processes the results and outputs a result y. The neuron of second layer 220 may process the result from first layer 210 using the method described for the neuron shown in FIG. 1.

One advantage of neural networks is the ability to learn. The learning process of neural networks is facilitated by updating the weights associated with each neuron of a layer. The weights for each neuron in a layer may be updated based on a particular learning rule. One type of learning rule is a back-propagation (BP) learning rule. The BP learning rule dictates that changes in the weights associated with the learning process are based on errors between actual outputs and desired outputs. In the network, an error associated with the output of a neuron is determined and then back propagated to the weights of that neuron. A number of training sets are inputted into the network in order to train the network. The neural network processes each training set and updates the weights of the neurons based on the error between the output generated by the neural network and the desired output

FIG. 3 is an example of a neural network 300 implementing the BP learning rule. Neural network 300 comprises a layer 310 and a layer 320. Layer 320 contains a J number of neurons. Layer 320 contains an L number of neurons. The neurons of both layers may be LTG, as illustrated in FIG. 1. Neural network 300 also includes an error determination unit 330 and a weight update unit 340.

In order to train network 300 according to the BP learning rule, a series of training sets xₘ where m=1, 2, . . . M are fed to network 300. Network 300 processes the training sets, in order to learn, by updating the weights. The learning process is described with reference to FIG. 3 and equations 1-7. A transfer function to determine if an input crosses a threshold T of each neuron in layers 310 and 320 may be a sigmoid function ƒ(s) expressed by equation (1):

$$f ( s ) = \frac{1}{1 + {ⅇ}^{- α s}} \qquad ( 1 )$$

where α is a gain factor and s is a sum of the weighted inputs. M is the number of the training set elements, wₗⱼ is the weight between the j^{th} neuron of layer 310 and the l^{th} neuron of layer 320 and Tₗ is the threshold of the l^{th} neuron of layer 320. For a certain training sample, m=(m=1,2, . . . ,M),z_{l,m} is the output of the j^{th} neuron of layer 310; y_{l,m} is the output of the l^{th} neuron of layer 320; d_{l,m} is the target value when l=L. The value s_{l,m} is the weighted sum from the j^{th} neuron of layer 310 to the l^{th} neuron of layer 320. A feed-forward calculation for determining output y_{l,m} is:

$${y}_{l , m} ( k ) = f ( {s}_{l , m} ( k ) ) = f ( {\sum }_{i = 0}^{n} {w}_{lj} ( k ) {z}_{j , m} ( k ) ) . \qquad ( 2 )$$

To describe an error back-propagation process performed by error determination unit 330 and weight update unit 340, several definitions are provided. A neuron error for neurons in layer 320 determined by error determination unit 330 is defined as,

$${ϵ}_{l j , m} ( k ) = \{ \begin{matrix}{d}_{l , m} - {y}_{l , m} ( k ) , l = L \\ {\sum }_{j} {w}_{l + 1 , ij} ( k ) {δ}_{lj , m} ( k ) , 1 \leq l < L\end{matrix} \qquad ( 3 )$$

where a weight error is defined as,

δ_{lj,m}(k)=ƒ′(s_{l,m}(k))ε_{lj,m}(k). (4)

Then a weight updating rule can be expressed as equation (5),

$${w}_{lj} ( k + 1 ) = {w}_{lj} ( k ) + η {\sum }_{m = 1}^{M} {δ}_{lj , m} ( k ) {y}_{l , m} ( k ) \qquad ( 5 )$$

where η is a learning rate. A term dwₗⱼ is defined as,

$${dw}_{lj} ( k + 1 ) = {\sum }_{m = 1}^{M} {δ}_{lj , m} ( k ) {y}_{l , m} ( k ) \qquad ( 6 )$$

which is performed by weight update unit 340. Then the weight change can be expressed as

$$Δ {w}_{lj} ( k + 1 ) = η \cdot dw = η {\sum }_{m = 1}^{M} {δ}_{lj , m} ( k ) {y}_{l , m} ( k ) \qquad ( 7 )$$

For each training set m, the weights can be updated as each training set is processed by network 300. On the other hand, the weights can be updated after all the training sets have been processed by network 300.

In order to accomplish the updating of weights after all the training sets have been processed, a hardware solution for accumulation of analog values is provided for weight update unit 340. One method for accumulating the analog value is a full parallel structure 400 as shown in FIG. 4. As seen in the FIG. 4, the outputs of each training set, y_{l,m} and the error, δ_{l,m}, are fed to multipliers 410, 420, and 430. The products of the multipliers are then summed by connecting the outputs of the multipliers to provide a result dw. The weight change results are then back propagated. For the full parallel structure, a multiplier is needed for each training set. Therefore, if the number of training sets M is large, a large number of multipliers are required. This causes an increase in the required hardware components.

### SUMMARY OF THE INVENTION

To improve performance of analog neural networks, certain aspects of the present invention relate to an analog accumulator circuit applied to weight updating so that the number of hardware components is less than a weight update unit utilizing a full parallel structure. The analog accumulator circuit conserves chip area by reducing the number of required multiplier circuits.

In accordance with one aspect of the present invention, there is provided a neural network utilizing the back-propagation learning rule comprising: at least one neuron having an input and an output; an error determination unit connected to the output of the at least one neuron; and a weight update unit connected to the error calculation unit and the at least one neuron, wherein the weight update unit is an analog accumulator.

In accordance with another aspect of the present invention, there is provided an analog accumulator for performing weight updating in a neural network utilizing the back-propagation learning rule, comprising: an input; an output; an analog adder connected to the input; an analog inverter connected to the analog adder; a voltage follower connected to the analog adder; and an analog memory connected to the analog adder and the output.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention as claimed.

The accompanying drawings, which are incorporated in and constitute a part of this specification, illustrate several embodiments of the invention and, together with the description, serve to explain the principles of the invention.

### BRIEF DESCRIPTION OF THE DRAWINGS

FIG. 1 is a diagram of a neuron of a neural network;

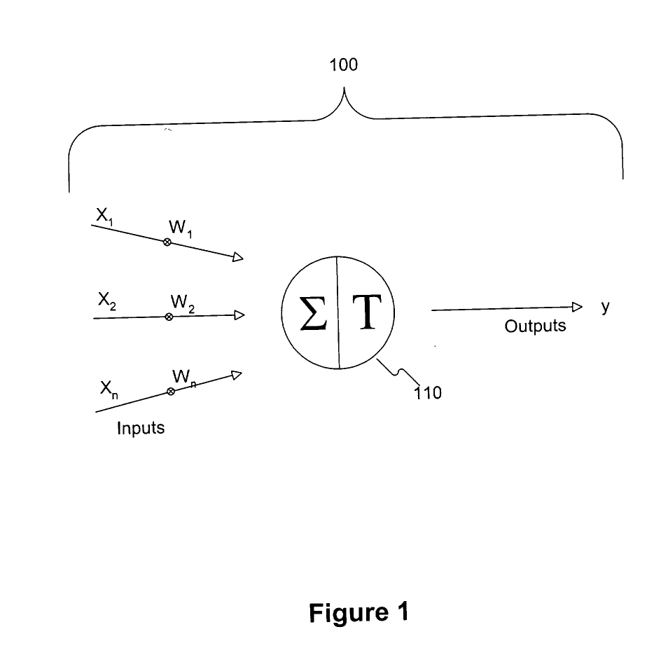

FIG. 2 is a diagram of a conventional multilayer neural network;

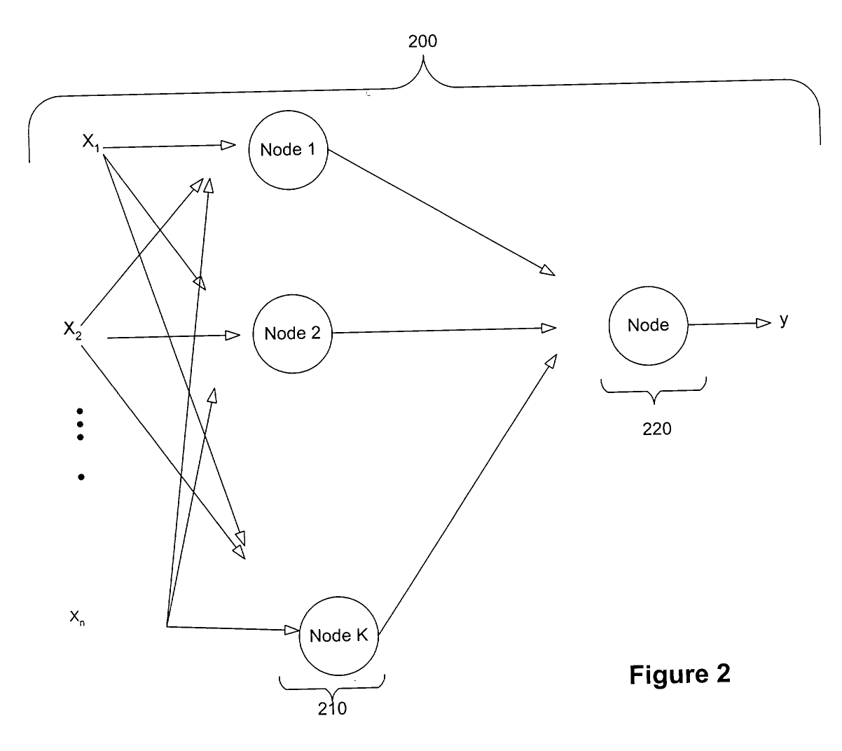

FIG. 3 is a diagram of a neural network utilizing a back-propagation learning rule;

FIG. 4 is a diagram of a full parallel weight update circuit used in a neural network;

FIG. 5 is a diagram of an analog accumulator consistent with an embodiment of the present invention;

FIG. 6 is a schematic diagram of a circuit for performing analog accumulation consistent with an embodiment of the present invention;

FIG. 7 is a diagram of HSPICE simulation parameters and results performed on the analog accumulation circuit shown in FIG. 6;

FIG. 8 is a diagram of results of tests performed on the analog accumulator shown in FIG. 6;

FIG. 9 is a diagram of a single layer neural network utilizing a back-propagation learning rule consistent with an embodiment of the present invention; and

FIGS. 10A and 10B are diagrams of results of tests performed on the neural network shown in FIG. 9.

### DESCRIPTION OF THE EMBODIMENTS

To improve performance of analog neural networks, certain aspects related to the present invention relate to an analog accumulator circuit applied in weight updating so that the number of hardware components is less than a weight update unit utilizing a full parallel structure. Analog accumulator circuits consistent with the present invention conserve chip area by reducing the number of required multiplier circuits.

Reference will now be made in detail to embodiments of the invention, examples of which are illustrated in the accompanying drawings. Wherever possible, the same reference numbers will be used throughout the drawings to refer to the same or like parts.

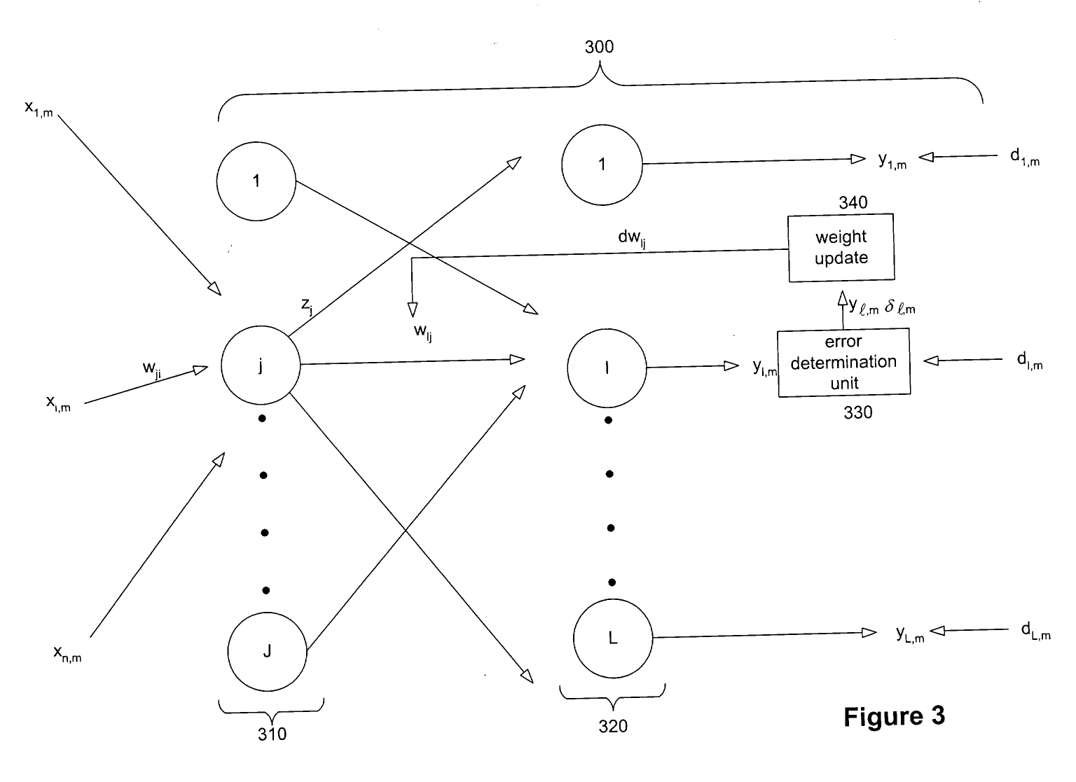

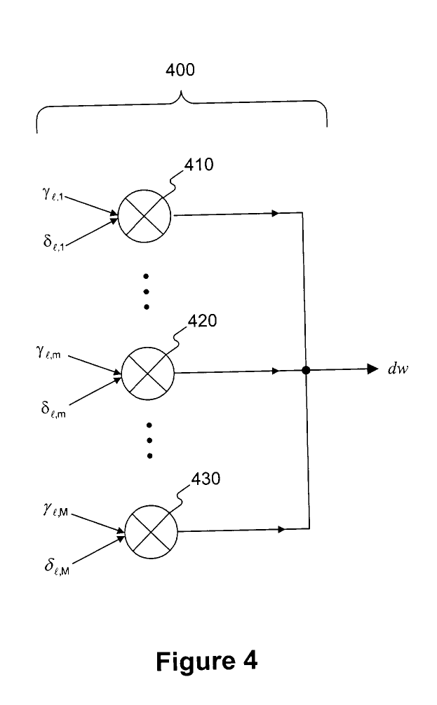

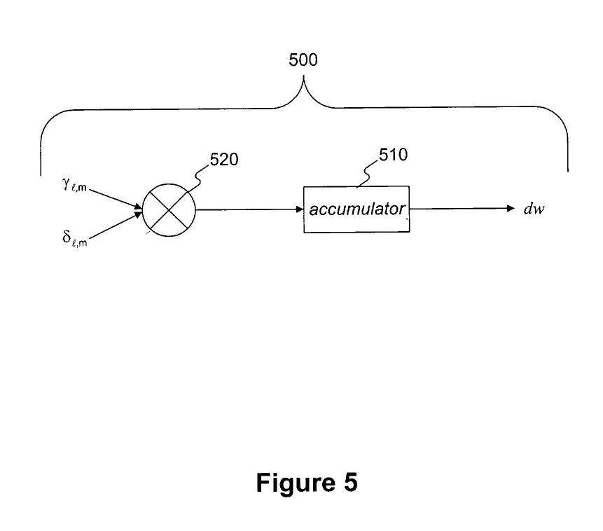

As discussed above, conventional neural networks utilizing the BP learning rule use a full parallel structure to update weights as shown in FIG. 4. However, as the number of training sets M increases, a corresponding number of hardware multipliers are required. An embodiment of the present invention provides a weight updating unit which does not require a separate multiplier for each training set. FIG. 5 illustrates a weight update unit 500 consistent with certain aspects related to the present invention. Weight update unit 500 can be utilized to update weights of a neuron in a neural network, such as neural network 300, as illustrated in FIG. 3. Weight update unit 500 functions by receiving an output y_{l,m} from a neuron and an error δ_{l,m} which is the error of y_{l,m} compared to a desired output d_{l,m}. The error δ_{l,m} may be determined using equation (4) described above for FIG. 3. Weight update unit 500 generates a weight update value dw by utilizing equation (6) described above for FIG. 3. An analog accumulator 510 generates weight update value dw by summing the products of y_{l,m} and δ_{l,m} output from a multiplier 520 for each training set m. As shown in FIG. 5, y_{l,m} and δ_{l,m} are provided to multiplier 520 and multiplied together. The product is transferred to analog accumulator 510 which performs an accumulation function. This process is repeated for each training set m. Once all the products from multiplier 520 have been accumulated, weight update value dw, which is the sum of all the products, is output. Weight update value dw is then transferred to the weight of the neuron. This structure is especially useful when the number of training sets is large because additional multipliers are not required.

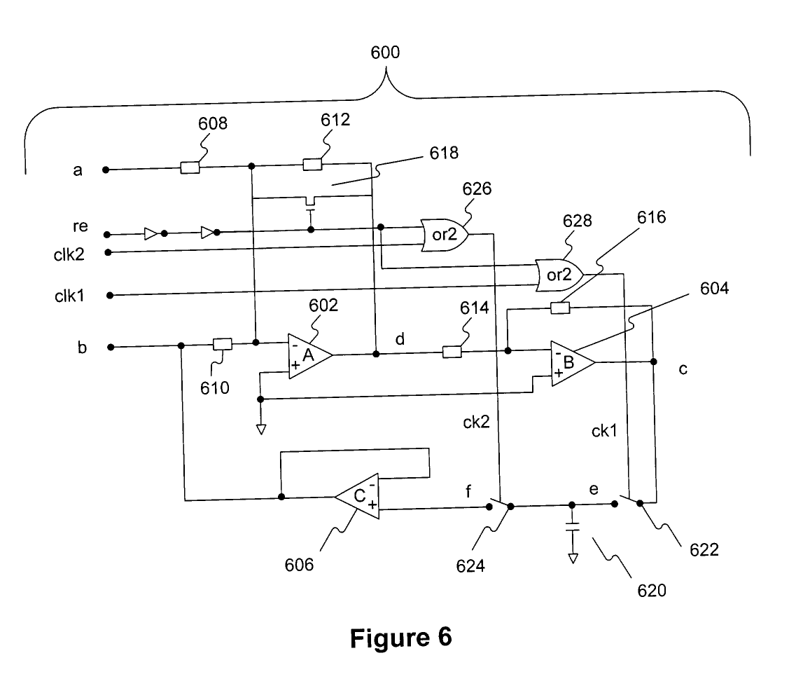

FIG. 6 shows a schematic of an analog accumulator 600 consistent with an embodiment of the invention. Analog accumulator 600 includes the following components: comparators 602, 604, and 606; resistors 608, 610, 612, 614, and 616; transistor 618; capacitor 620; switches 622 and 624; and gain “or” gates 626 and 628. Resistors 608, 610, 612, 614, and 616 can be, for example, all 10 kΩ resistors. Transistor 618 may be provided as an n-type metal oxide semiconductor (NMOS) transistor. Comparator 602 together with resistors 608, 610, and 612 function as an analog adder. Comparator 604 together with resistors 614 and 616 function as an analog inverter. Comparator 606 functions as a voltage follower. Capacitor 620 functions as a capacitor-type analog memory in which charge is stored. Analog accumulator 600 has the following input signals: “re” is a reset signal and “clk1” and “clk2” are non-overlapping clock signals. A control signal “ck1” is generated by an “or” operation of the signals “re” and “clk1”. A control signal “ck2” is generated by an “or” operation of the signals “re” and “clk2”. Switch 622 or 624 is closed if the control signals “ck1” or “ck2”, respectively, is high. Otherwise, switch 622 or 624 is open. An input signal to be accumulated is input at point “a”. An output signal is measured at point “b”.

When signal “re” is high, transistor 618 turns on. The voltage at a point d is equal to the inverting input voltage of comparator 602. If the amplification factor of comparator 602 is large enough, the voltage d is 0. If signals “ck1” and “ck2” are high when “re” is high, switches 622 and 624 are closed so that all voltages, V_{b}, V_{c}, V_{d}, Vₑ, V_{f}, at points “b”, “c”, “d”, “e”, and “f”, respectively, are 0.

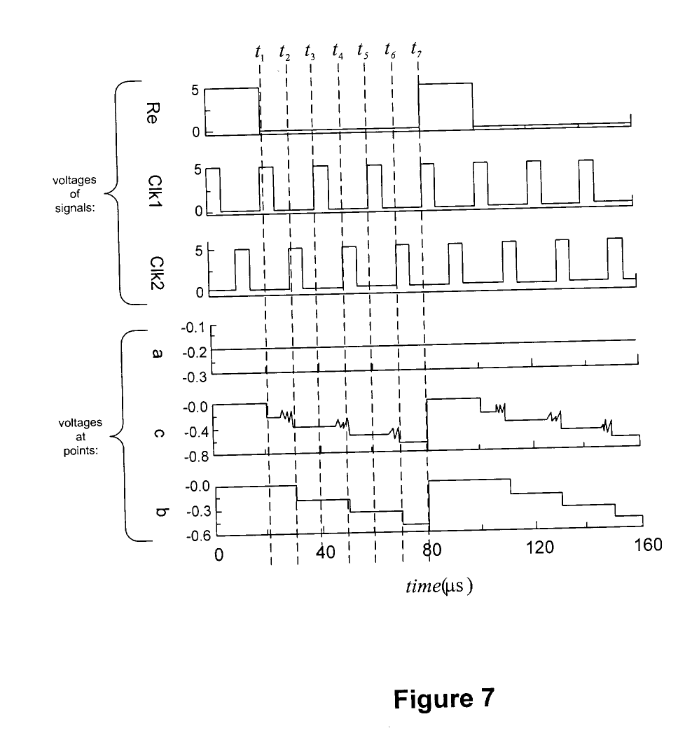

The processing of accumulator 600 in FIG. 6 will now be described. FIG. 7 shows the results of a simulation of accumulator 600 performed on HSPICE which is an analog circuit simulator. For purposes of the test, an input voltage applied at point “a” was applied and held at a constant value −0.2V throughout the time period t₁ through t₇. When signal “re” is low, the voltage at point “a” is applied to the accumulator and, for the purpose of determining other voltages in the accumulator, is given unique designations for different time intervals as follows:

$$a = \{ \begin{matrix}{a}_{1} & {t}_{1} \leq t < {t}_{3} \\ {a}_{2} & {t}_{3} \leq t < {t}_{5} \\ {a}_{3} & {t}_{5} \leq t < {t}_{7}\end{matrix}$$

(8) where t₁ through t₇ are shown in FIG. 7. At time t₁, signal “clk1” rises from 0 to 5V and switch 622 is closed. At time t₁, the voltages at the various points are V_{d}=−a₁; V_{c}=Vₑ=a₁; and V_{f}=V_{b}=0. At time t₂, signal “clk2” rises from 0 to 5 v, switch 624 is closed, and the voltages at the various points are Vₑ=V_{f}=V_{b}=a₁, V_{d}=−2a₁, and V_{c}=2a₁. At time t₃, signal “clk2” rises from 0 to 5V and switch 624 is closed. At time t₃, the voltages at the various points are V_{d}=−(a₁+a₂), V_{c}=Vₑ=a₁+a₂, and V_{f}=V_{b}=a₁. At time t₄, signal “clk1” rises from 0 to 5V and switch 622 is closed. At time t₄, Vₑ=V_{f}=V_{b}=a₁+a₂, V_{d}=−(a₁+2a₂), and V_{c}=a₁+2a₂. At time t₅, signal “clk1 rises from 0 to 5V and switch 622 is closed. At time t₅, V_{d}=−(a₁+a₂+a₃), V_{c}=Vₑ=a₁+a₂. At time t₆, signal “clk2” rises from 0 to 5V and switch 624 is closed. At time t₆, Vₑ=Vₜ=V_{b}=a₁+a₂. At time t₇, signal “clk2” rises from 0 to 5V and switch 624 is closed. At time t₇, Vₑ=Vₜ=V_{b}=a₁+a₂+a₃. Thus, since the voltage at point “b”, referred to herein as output voltage V_{b}, is equal to the sum of the input voltages, the circuit accomplishes the accumulation.

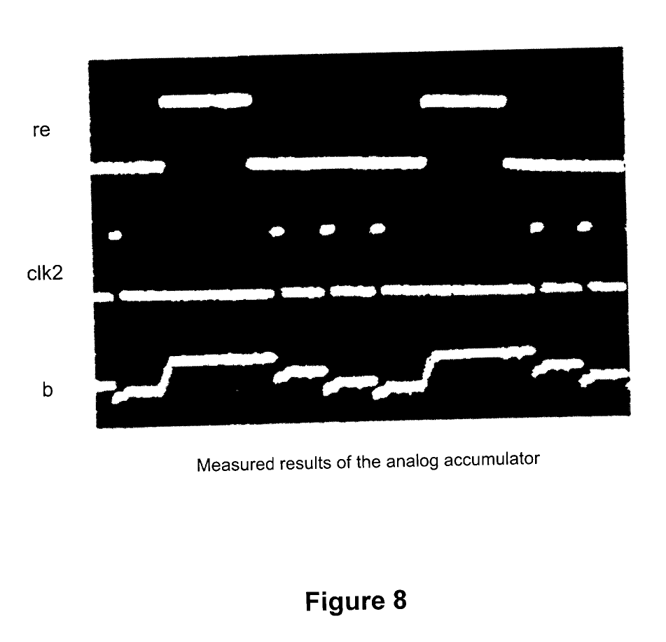

FIG. 8 shows an oscilloscope display of results of tests performed on an analog accumulator constructed to have the features of accumulator 600. In the test, input voltage a was set to a constant −0.2V. The top two waveforms of FIG. 8 are reset signal “re” and second clock signal “clk2”. The output voltage at point b is shown as the third waveform. As seen can be seen in FIG. 8, analog accumulator 600 successfully outputted the accumulation of input voltage a.

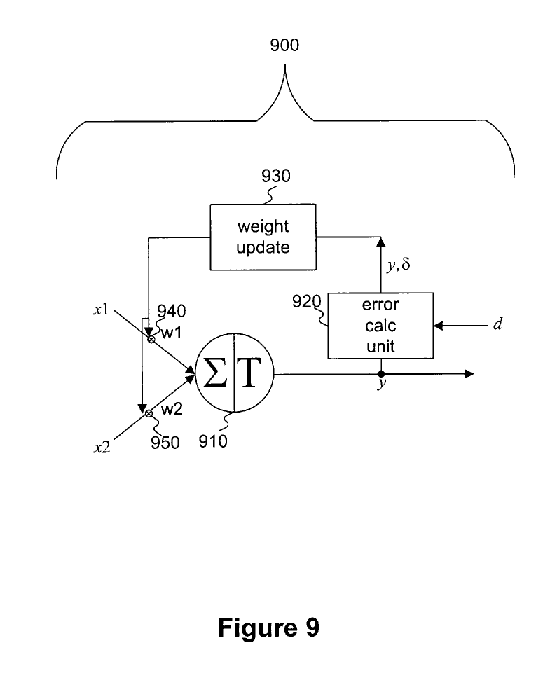

An embodiment of the invention will now be described for the analog accumulator applied to a single layer neural network performing the BP learning rule. FIG. 9 shows a circuit diagram of a single layer neural network 900. Network 900 includes a neuron 910, an error calculation unit 920, a weight update unit 930, and multipliers 940 and 950. In this embodiment, weight update unit 930 is provided with an analog accumulator 600 as shown in FIG. 6. Network 900 functions by receiving two inputs x1 and x2 at neuron 910. Inputs x1 and x2 are fed to multipliers 940 and 950, respectively, where input x1 and x2 are multiplied by weights w1 and w2, respectively, to generate weighted products. The weighted products are transferred to neuron 910. Neuron 910 sums the weighted products and compares the sum to a threshold value T. An output y is generated by neuron 910 and provided to error calculation unit 920. An error δ is generated by comparing the output y with a desired target output d. The error δ and the output y are provided from error calculation unit 920 to weight update unit 930. The error δ is multiplied by the output y to determine the weight change. Then, weight update unit 930 accumulates the weight changes. The accumulation performed by weight update unit 930 is described above in the description of FIG. 6. Once weight update unit 930 has accumulated all the weight changes, the accumulated weight change is then fed back to weights w1 and w2 stored at multipliers 940 and 950, respectively. Weight updating is then achieved by multiplying the weights w1 and w2, stored at multipliers 940 and 950, respectively, by the accumulated weight change value.

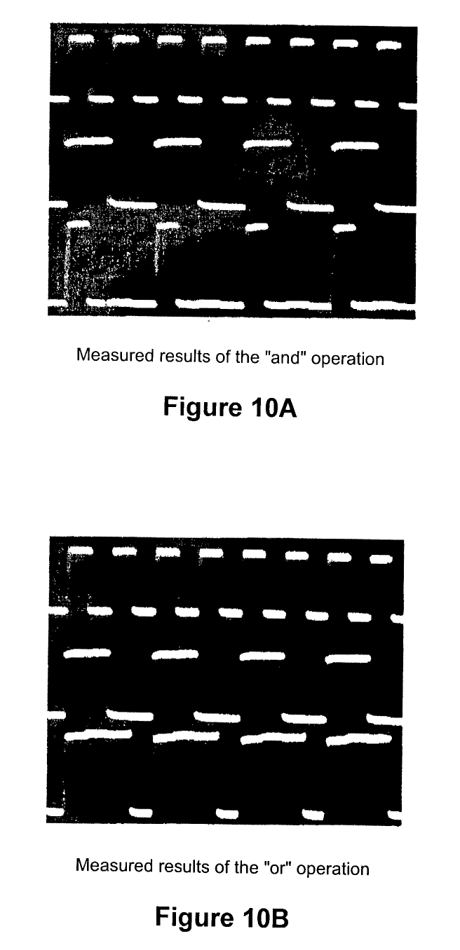

FIGS. 10A and 11B illustrate oscilloscope displays of results of tests performed on neural network 900 shown in FIG. 9. The tests were performed by inputting x1 and x2 and observing the results. FIG. 10A shows the output y for the network 900 when desired target output d for the circuit is a logical “and” operation of inputs x1 and x2. As seen in the FIG. 10A, the output y was equal to the logical “and” of inputs x1 and x2.

FIG. 10B shows the output y for network 900 when desired target output d for the network is a logical “or” operation of inputs x1 and x2. As seen in FIG. 10B, the output y was equal to the logical “or” of inputs x1 and x2.

It will be apparent to those skilled in the art that various modifications and variations can be made in the analog accumulator and neural network of the present invention and in construction of this analog accumulator and neural network without departing from the scope or spirit of the invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A neural network, comprising:
at least one neural neuron having a neuron input to receive an input value modified by a weight and a neuron output on which to provide a neuron output value;
an error determination unit, coupled to the neuron output, to determine and provide an error in the output value; and
a weight update unit coupled to receive the error provided by the error determination unit and to provide an updated weight for determining the input value applied to the neuron input;
wherein the weight update unit is an analog accumulator.

2. The neural network as set forth in claim 1, wherein the analog accumulator comprises:
an accumulator input;
an accumulator output;
an analog adder coupled to the accumulator input for summing voltages supplied from the accumulator input;
an analog inverter coupled to the analog adder for inverting voltages supplied from the analog adder;
an analog memory coupled to the analog inverter for storing voltages supplied from the analog inverter; and
a voltage follower coupled to the analog memory and the accumulator output for buffering voltages supplied from the analog memory to the accumulator output.

3. The neural network as set forth in claim 2, wherein the analog adder comprises:
a first comparator having an inverting input, a non-inverting input, and an output;
a first resistor coupled between the accumulator input and the first comparator inverting input;
a second resistor coupled between the first comparator inverting input and the first comparator output; and
a third resistor coupled between the accumulator output and the first comparator inverting input.

4. The neural network as set forth in claim 3, wherein the analog inverter comprises:
a second comparator having an inverting input, a non-inverting input, and an output;
a fourth resistor coupled between the first comparator output and the second comparator inverting input; and
a fifth resistor coupled between the second comparator inverting input and the second comparator output.

5. The neural network as set forth in claim 4, wherein the analog memory comprises:
a capacitor having an end selectively coupled to each of the second comparator output and the voltage follower.

6. The neural network as set forth in claim 5, wherein a first switch is interposed between the capacitor end and the second comparator output.

7. The neural network as set forth in claim 5, wherein the voltage follower comprises:
a third comparator having an inverting input, a non-inverting input and an output, wherein the third comparator inverting input is connected to the third comparator output, the third comparator non-inverting input is connected to the capacitor end, and the third comparator output is coupled to the accumulator output and the first comparator inverting input.

8. The neural network as set forth in claim 7, wherein a second switch is interposed between the capacitor end and the third comparator non-inverting input.

9. An analog accumulator for performing weight updating in a neural network, comprising:
an accumulator input;
an accumulator output;
an analog adder coupled to the accumulator input for summing voltages supplied from the accumulator input;
an analog inverter coupled to the analog adder for inverting voltages supplied from the analog adder;
an analog memory coupled to the analog inverter for storing voltages supplied from the analog inverter; and
a voltage follower coupled to the analog memory and the accumulator output for buffering voltages supplied from the analog memory to the accumulator output.

10. The analog accumulator as set forth in claim 9, wherein the analog adder comprises:
a first comparator having an inverting input, a non-inverting input, and an output;
a first resistor coupled between the accumulator input and the first comparator inverting input;
a second resistor coupled between the first comparator inverting input and the first comparator output; and
a third resistor coupled between the accumulator output and the first comparator inverting input.

11. The analog accumulator as set forth in claim 10, wherein the analog inverter comprises:
a second comparator having an inverting input, a non-inverting input, and an output;
a fourth resistor coupled between the first comparator output and the second comparator inverting input; and
a fifth resistor coupled between the second comparator inverting input and the second comparator output.

12. The analog accumulator as set forth in claim 11, wherein the analog memory comprises:
a capacitor having an end selectively coupled to each of the second comparator output and the voltage follower.

13. The analog accumulator as set forth in claim 12, wherein a first switch is interposed between the capacitor end and the second comparator output.

14. The analog accumulator as set forth in claim 12, wherein the voltage follower comprises:
a third comparator having an inverting input, a non-inverting input and an output, wherein the third comparator inverting input is connected to the third comparator output, the third comparator non-inverting input is connected to the capacitor end, and the third comparator output is coupled to the accumulator output and the first comparator inverting input.

15. The analog accumulator as set forth in claim 14, wherein a second switch is interposed between the capacitor end and the third comparator non-inverting input.

16. The analog accumulator as set forth in claim 9, wherein the accumulator input is for coupling to an error determination unit.

17. The analog accumulator as set forth in claim 9, wherein the accumulator output is for coupling to at least one neuron of the neural network.

18. A method for performing weight updating in a neural network, comprising:
receiving weight change values based on outputs of a neural network neuron;
determining a total weight change value by accumulating all weight change values for the outputs of the neural network neuron; and
outputting the total weight change value.

19. The method as set forth in claim 18, wherein the weight change values are determined from the outputs and an error determined by comparing the outputs of the neural network neuron with predetermined outputs.

20. The method as set forth in claim 18, wherein the total weight change value determination comprises:
sequentially receiving the weight change values comprising a first, second, and third weight change value;
storing the first weight change value;
receiving the second weight change value;
summing the first weight change value and the second weight change value to generate an intermediate sum;
storing the intermediate sum;
receiving the third weight change value;
summing the third weight change value and the intermediate sum to generate the total weight change value; and
storing the total weight change value.

21. A method for performing neural network processing for a neural network neuron, comprising:
receiving neural network neuron inputs;
multiplying the neural network neuron inputs by neural network neuron weights to generate weighted products;
transferring the weighted products to the neural network neuron;
summing the weighted products;
determining an output for the neural network neuron by applying the sum to a transfer function;
determining an error value by comparing the output to a determined output;
multiplying the error value by the output to determine a weight change value;
transferring the weight change value to a weight update unit;
accumulating the weight change value in the weight update unit to generate a total weight change value; and
updating the neural network neuron weights by multiplying the accumulated weight change value by the neural network neuron weights.

22. The method as set forth in claim 21, wherein the weight change value accumulation further comprises accumulating multiple weight change values generated from multiple neural network neuron outputs and multiple error values.
